(19) United States
(12) Patent Application Publication
(10) Pub. No.: US 2008/0013131 A1
(43) Pub. Date: Jan. 17, 2008

(54) IMAGE FORMING APPARATUS, CONTROL METHOD FOR IMAGE FORMING APPARATUS AND MEMORY MEDIUM

(75) Inventors: Hiroyuki Hosogoshi, Yokohama-shi (JP); Shigeru Fujita, Yokohama-shi (JP); Hiroki Horikoshi, Kawasaki-shi (JP); Akira Ichimura, Tokyo (JP); Hideki Takemura, Tokyo (JP); Takeshi Kuga, Inagi-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/774,822

(22) Filed: Jul. 9, 2007

(30) Foreign Application Priority Data
Jul. 11, 2006 (JP) 2006-190544

(51) Int. Cl. H04N 1/40

(52) U.S. Cl. 358/471

(57) ABSTRACT

The invention is to provide an image forming apparatus, for printing an image based on image data, capable of deleting data unnecessary for the user, thereby effectively utilizing limited memory area. The invention provides an image forming apparatus for printing an image based on image data, including a memory unit for memorizing the image data; a determination unit for determining a category of the image data; and a selection unit for selecting whether to erase or to store the image data after being printed, according to a result of determination by the determination unit.

### BACKGROUND OF THE INVENTION

1. Field of the Invention

The present invention relates to an image forming apparatus capable of receiving and accumulating jobs from plural data processing apparatuses through a predetermined communication medium, a control method for such image forming apparatus, and a memory medium.

2. Description of the Related Art

In recent years, information processing systems, in which a color printing apparatus is capable of communicating with and plural host computers, have become popular and are utilized widely. In such situation, numerous electronic documents are prepared in the information processing systems, and a demand for outputting such documents to the color printing apparatus is increasing, whereby a high-speed and inexpensive color printing apparatus is strongly desired.

An image forming apparatus of ink jet system is generally equipped with a carriage which supports a recording unit (print head) and an ink tank, a conveying unit for conveying a recording sheet, and a control unit for controlling these units. The print head, capable of discharging liquid droplets from plural discharge ports, executes a serial scanning motion in a direction (main scan direction) perpendicular to the conveying direction (sub scan direction) of the recording sheet, which, in a non-recording state, is intermittently conveyed in an amount equal to a recording width. Also in an image forming apparatus capable of color recording, a color image is formed by superposing ink droplets discharged by print heads of plural colors.

In the image forming apparatus of ink jet system, the ink discharge is executed for example by a thermal system or by a piezo system. In the thermal system, a heat generating element is provided in the vicinity of the discharge port and by applying an electrical signal to the heat generating element to locally heat the ink, a pressure change is caused to discharge the ink from the discharge port. In the piezo system, an electric/pressure conversion means such as a piezo element is used to provide the ink with a mechanical pressure, thereby discharging the ink.

These recording systems perform recording of a character or an image, by discharging an ink as a minute liquid droplet, according to a recording signal, from a discharge port onto a recording medium. Also these recording systems, being of non-impact methods, have advantages of a low noise level, a low running cost and an easy compactification of the apparatus. Thus, they are widely utilized as image forming (recording) means in a copying machine, a printer, a facsimile and the like, to be used in combination with a computer or a word processor or in the stand-alone mode.

The conventional ink jet recording system requires the use of an exclusive coated paper, equipped with an ink absorbent layer, in order to obtain a color image of a high color development without an ink blotting. In recent years, however, also commercialized is a recording system, having printability on a plain paper, that is commonly used in a printer or a copying machine, for example owing to improvements in the ink.

Also required is adaptability to various recording media, such as an OHP sheet, a cloth and a plastic sheet. In order to respond to such requirement, there are being underway development and commercialization of a recording apparatus capable of optimum recording regardless of the type of the recording medium, even when recording media different in ink absorbing property are selected according to the purpose.

Also as to the size of the recording medium, a large format is required for an advertisement poster or a woven cloth for clothings. Thus, the image forming system of ink jet type is showing increasing demands in various fields as an excellent recording means, and is also required to provide images of an even high quality and to achieve a further higher speed.

In general, a color ink jet recording process realizes a color recording by means of inks of four colors, namely three color inks of cyan (C), magenta (M) and yellow (Y) and a black (K) ink. Such color ink jet recording, in contrast to the monochromatic ink jet recording which is used for printing characters only, requires various factors such as a color developing property, a gradational property and a uniformity, for recording a color image.

Also in order to form a natural image of multi gradational levels in a higher quality, there are utilized 7-color inks including 3 colors of light C (LC), light M (LM) and light Y (LY) in addition to the conventional 4 colors of cyan (C), magenta (M), yellow (Y) and black (K). In this manner there can be realized an image with a reduced granular feeling in a highlight area.

In the image forming apparatus of ink jet system, there is available a printer equipped with a large-capacity memory apparatus such as a hard disk drive. The large-capacity memory apparatus in such printer is utilized for spooling in a print job, thus being effective for improving the handling property in case of executing an image processing or a printing process on the image data. Also as the image data can be stored for a prolonged period, the print output can be executed repeatedly without relying on the host computer.

However, the image data stored in the memory apparatus is often non-compressed, so that a large the memory area is occupied as the number of data stored in the memory apparatus increases. Particularly in a large size printing printer which is often used for outputting a large-sized image, it is very important to device a method of effectively utilizing the limited memory area.

Therefore, proposed is a solving method utilizing means which discriminates whether the data, stored in the memory apparatus in the image forming apparatus, has an electronic watermark. This solving method is capable of executing such control that when an output request is absent for a predetermined period for the image data having an electronic watermark, it is permitted to delete such image data from the memory apparatus (for example cf. Japanese Patent Application Laid-Open No. 2003-216721).

In such conventional methods, however, attention is not necessarily paid to the difference in the type of data, in erasing the image data from the memory apparatus. For example in the method described in Japanese Patent Application Laid-Open No. 2003-216721, the criteria for deleting the data from the memory apparatus are that “an electronic watermark is embedded in image data” and “an output request is again absent within a predetermined time”, and are not related with the type of each data.

Therefore, it is not always realized to execute such control that accords to the characteristics of each data, nor to reflect the intention of the user. Thus, there may result an inconvenience by an erroneous erasure of the data necessitated by the user.

### SUMMARY OF THE INVENTION

In consideration of the foregoing, an object of the present invention is to provide an image forming apparatus, for printing an image based on image data, capable of deleting data that is unnecessary to the user, thereby realizing an effective utilization of the limited memory area.

Further features of the present invention will become apparent from the following description of exemplary embodiments with reference to the attached drawings.

### BRIEF DESCRIPTION OF THE DRAWINGS

FIG. 1 is a block diagram illustrating an image forming system 100, constituting an exemplary embodiment 1 of the present invention.

FIG. 2 is a perspective view illustrating a specific example of a printing unit 22 in the exemplary embodiment 1.

FIG. 3 is a chart illustrating a relationship among a category, a CAD, a poster and a photograph in the exemplary embodiment 1.

FIG. 4 is a flow chart showing detailed operations of an image data category determination (S15) in the exemplary embodiment 1.

FIG. 5 is a flow chart illustrating basic operations, in the exemplary embodiment 1, that a host computer transmits a print job and a printing process is execoted.

FIG. 6 is a flow chart illustrating operations in the exemplary embodiment 1, not utilizing an image category determination unit and a category setting unit.

FIG. 7 is a flow chart illustrating operations of executing a printing process with image data stored within the image forming apparatus 100.

FIG. 8 is a flow chart illustrating operations of an exemplary embodiment 2 of the present invention.

FIG. 9 is a chart illustrating a relationship among a category, a CAD, a poster and a photograph in an exemplary embodiment 2.

### DESCRIPTION OF THE EMBODIMENTS

The present invention can be executed advantageously by a following exemplary embodiment.

### Exemplary Embodiment 1

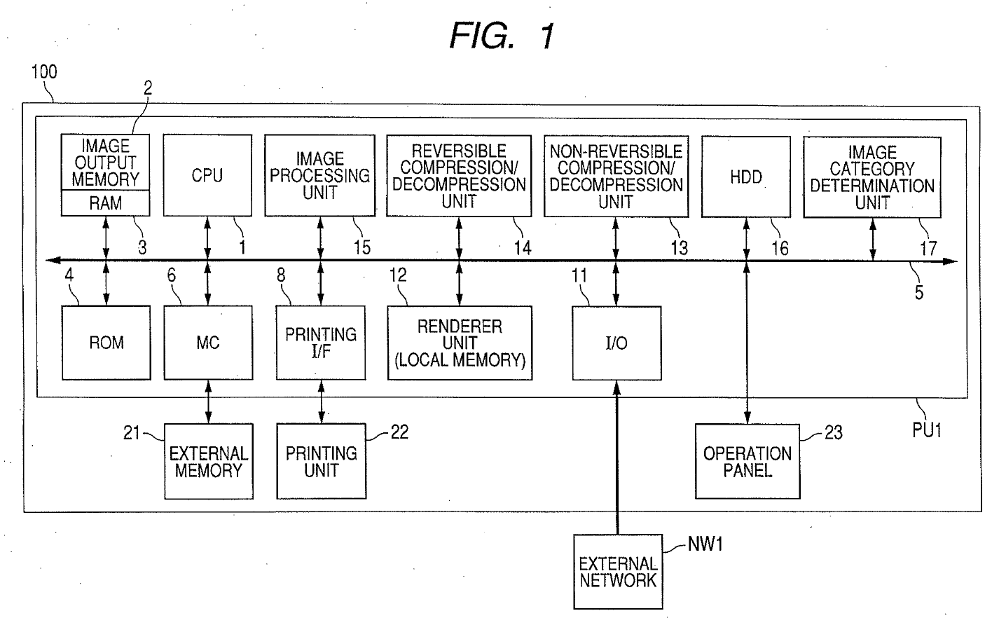

FIG. 1 is a block diagram illustrating an image forming system (image forming apparatus) 100 constituting an exemplary embodiment 1 of the present invention.

The image forming system 100 is for example an ink jet printing apparatus, which forms, according to print information, form information, a macrocommand and so on, a corresponding character pattern or a corresponding form pattern. It also forms (prints) an image on a recording medium such as a recording sheet, and stores the image data in a memory apparatus after the printing.

The image forming system 100 is equipped with a print control unit PU1, an external memory 21, a print unit 22 and an operation panel 23.

The print control unit HDD includes a CPU 1, an image output memory 2, a RAM 3, a ROM 4, a system bus 5, a memory controller 6, a print interface 8, an I/O 11 and a renderer unit 12. The print control unit PU1 further includes a non-reversible compression/decompression unit 13, a reversible compression/decompression unit 14, an image processing unit 15, an HDD 16 and an image category determination (or classification) unit 17.

The above-mentioned print information is information supplied from an external information source such as a host computer, connected through a network or directly by an interface.

The CPU 1 is constituted of a high-speed CPU of RISC type, and comprehensively controls accesses to the devices connected to the system bus 5, based on a control program stored in the ROM 4 or a control program stored in the external memory 21. The CPU 1 finally outputs an image signal for an output image, to a printing unit 22 connected through the printing interface 8. The control among the blocks and the image data communication in the printer control unit PU1 are executed by an exchange of a packet-structured data.

The ROM 4 stores the control program for CPU 1, and data necessary for controlling the image forming system 100. The CPU 1 is capable of communication with an external apparatus such as a host computer, through the I/O 11 and an external network NW1.

The communication with the host computer is executed through an external network, but the communication may also be made by a connection with the host computer through a direct interface such as of an unillustrated display apparatus.

The RAM 3 functions as a main memory, a work area of the CPU 1, etc., and receives compressed image date from the host computer through the external network NW1. The RAM 3 is capable of expanding the memory capacity, by an optional RAM connected to an unillustrated expansion port.

The image output memory 2 is a memory for image output, prepared on the RAM 3. The image output memory 2 records, as an output memory, raster data prepared in the renderer unit 12 for a PDL job, and records raster data prepared by the host computer for a raster job. The HDD (hard disk) 16 is used for storing the expanded image data.

The memory controller 6 controls an access to the external memory 21 such as a DRAM. The hardware renderer 12 includes a local memory therein. The hardware renderer 12, for a PDL job, executes a direct interpretation of a display list (hereinafter represented as “DL”) transferred to the local memory, or a DL being on the RAM 3, thereby preparing raster data and attribute data corresponding to each pixel of the raster data.

The non-reversible compression/decompression unit 13 decompresses (or expands) the image data which is entered from the host computer into the RAM 3 through the external network NW1 and which is in a non-reversible compressed state. The non-reversible compression/decompression unit 13 reads a compressed code stored in the RAM 3, and, after a decompression processing, writes the image data into the HDD 16. JPEG may be used as the method of non-reversible compression.

In a compression encoding process, a target compression rate is set. The compression process is repeated, if necessary, by changing the parameter (quantizing table).

The function of the reversible compression/decompression unit 14 is similar to that of the non-reversible compression/decompression unit 13, except that the compression method to be handled is a reversible compression. Pack-bits method may be used as the method of reversible compression.

The pack-bits method is a combination of a non-encoding and a run-length encoding, and a unit thereof is constituted of two bytes or more. A first byte is a control byte indicating how many same data continue or how many different data continue, followed by data. When data of a same type continue, the data can be represented by 2 bytes, and, when data of different types continue, the data can be represented by a number of bytes, larger by one byte than the number of data.

In the exemplary embodiment 1, the non-reversible compression and the reversible compression may both be used for the compression, and may be used selectively according to the purpose. In the exemplary embodiment 1, the image data in a compressed state is stored in the HDD 16 after decompression, but such embodiment is not only one. In the exemplary embodiment 1, it is also possible to store the image data in the compressed state in the HDD 16 and to expand the image data immediately before the image processing.

The image processing unit 15 applies, to the raster data, any one or combination of an image processing for a character, a image processing for an image, an image processing for graphics, an image processing for a color image, an image processing for a monochromatic image and an image processing for a fine line, based on the attribute data.

The image category determination unit 17 classifies each image data into categories by referring to a print mode setting, relating to the image data stored in the HDD 16.

The “categories” includes a category in which the image data is erased from the HDD 116, and a category in which the image data is not erased from the HDD 16.

The function of the HDD 16 for each image data follows a process content, set by the user, for each category. The user setting of the process content of the HDD 16, related with each category, may be input directly from the operation panel 23, or from the host computer through the external network NW1 and the input bus 5.

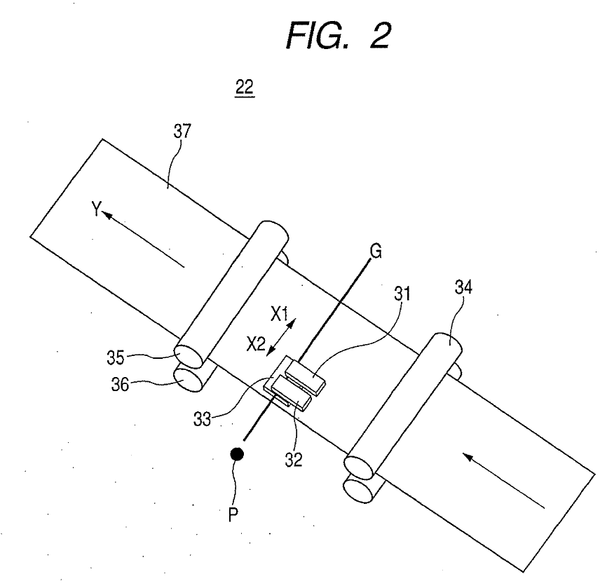

FIG. 2 is a perspective view illustrating a specific example of the printing unit 22 in the exemplary embodiment 1.

The printing unit 22 includes a forward scan printing head 31, a backward scan printing head 32, a carriage 33, a sheet feeding roller 34, an auxiliary roller 35, and a sheet conveying roller 36.

The forward scan printing head 31 is a multiple head in which ink tanks, respectively containing 4-color inks of black, cyan, magenta and yellow, and four printing heads, respectively corresponding to the ink tanks, are integrated. The four printing heads are arranged in an order of the inks of black, cyan, magenta and yellow colors, along a forward scanning direction indicated by an arrow X1.

The backward scan printing head 32 is constructed in a similar manner as the forward scan printing head 31. The four printing heads, corresponding to the 4-colored inks, are arranged, in contrast to the forward scan printing head 31, in an order of yellow, magenta, cyan and black along the forward scanning direction X1.

The carriage 33 supports the forward scan printing head 31 and the backward scan printing head 32, and can be moved along the main scanning directions X1, X2 in the forward and backward directions. The carriage 33 is located in a home position P in a stand-by state for example when the printing operation is not executed. The carriage 33 is moved in the main scanning directions X1 and X2 by an unillustrated moving mechanism, while being guided by a guide rod G.

The sheet conveying roller 36 presses a recording sheet 37, serving as a printing medium, in cooperation with the auxiliary roller 35, and intermittently conveys the sheet in a sub scanning direction indicated by an arrow Y. The sheet feeding roller 34 feeds the recording sheet 37 and presses the recording sheet 37 in a similar manner as in the sheet conveying roller 36 and the auxiliary roller 35.

Now, there will be described an operation, in the image forming system 100, of adaptively switching whether or not to store the data in the memory apparatus.

The exemplary embodiment 1 has, as described above, a unit for classifying the image data into plural categories by referring to a print mode setting, contained in the print job data, and a unit for executing a process, set by the user for each category, on the image data.

The image forming system 100, in classifying the image data into plural categories, refers at first to print mode setting information, contained in the print job data. In instructing a printing, the user can set the print mode through a printer driver of the host computer or the operation panel in the main body of the printer. The print mode setting can designate not only an image quality of the printed material and a print speed at the printing operation, but also an application of the printed material. Specific examples of the application of the printed material include a standard print, a business document, a CAD, a poster, a photograph and a draft printing. In the exemplary embodiment 1, such applications are taken as image categories, for each of which the control is executed according to the content of category setting executed by the user.

The user can set the image category through the printer driver of the host computer or through the operation panel in the main body of the printer, thereby achieving operations matching the intention of the user.

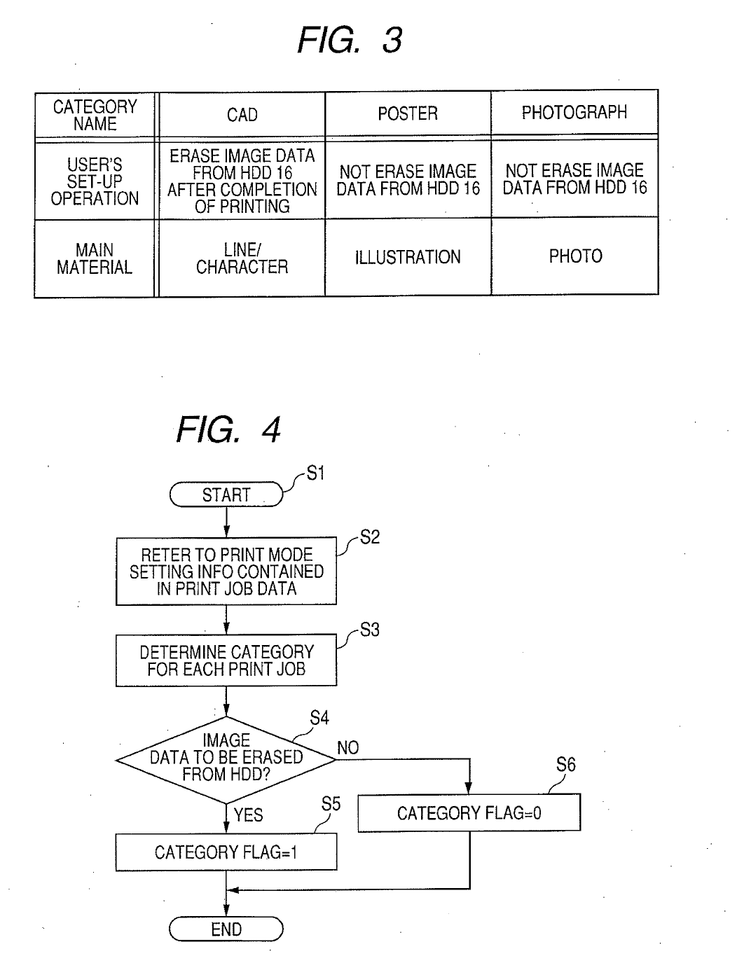

FIG. 3 is a chart illustrating a relationship, in the exemplary embodiment 1, among the category, CAD, poster and photograph.

For example, the image data for CAD application, being so set as to be erased from the HDD 16 after printing, as illustrated in FIG. 3, is erased from the HDD 16.

On the other hand, the image data for poster application is so set as to be stored in the HDD 16 even after printing, while the image data for photograph application is so set as to be stored in the HDD 16 even after printing. In this manner, the setting is executed individually. In case of setting “to erase the data from the HDD 16 after the printing” as in the case of CAD, the image data is stored in the HDD 16 only during the printing process, in order to promptly execute the image processing and the printing process, and the data is erased from the HDD 16 when the printing is completed.

On the other hand, in case of setting for “storage in the HDD 16 even after the printing”, as in poster and photograph, the data erasure is not executed at all.

When the user changes the content of image category setting, the data in the course of printing process is processed in continuation according to the setting prior to the change. Also the image data already stored in the HDD 16 continues to be stored in the HDD 16, and the printing based on the category determination unit is controlled anew at the next printing operation. The setting of each category may be changed by the user from time to time, so that there can be flexibly accommodated a setting change, resulting for example from a change in the environment of use of the image processing system.

The exemplary embodiment 1 has, as described above, a unit for classifying the image data into plural categories by referring to a print mode setting, contained in the print job data, and a unit for executing a process, set by the user for each category, on the image data.

In the following, there will be described basic operation of a reciprocating printing.

The carriage 33, which is in the home position P in a stand-by state, moves in the forward scan direction X1 in response to a recording start command. Together with this operation, the four printing heads in the forward scan printing head 31 discharge the inks from the respective plural ink discharge ports according to the image data, thereby printing characters and the like by means of such inks, on the recording sheet 37.

When the printing operation of image data of one row to the end of the recording sheet 37 is completed, the sheet conveying roller 36 rotates in a direction indicated by an arrow, thereby advancing the recording sheet 37 in the direction Y by a predetermined width. Subsequently the carriage 33 moves in the backward scan direction X2, while the four printing heads in the backward printing head 32 discharge inks from the plural discharge ports according to the image data, thereby printing characters and the like by means of such inks, on the recording sheet 37.

Then the carriage returns to the home position P. Thereafter, the sheet conveying roller 36 again advances the recording sheet 37 in the direction Y by a predetermined width. By the repetition of such scanning motion of the heads and the sheet conveying operation, an image is printed in succession on the recording sheet 37.

The image forming system 100 includes, though not illustrated, a motor driver for driving a carriage motor which drives the carriage, a sheet feeding motor which drives the sheet feeding roller, a sheet conveying motor which conveys the recording sheet, and a print head driver for driving the printing head.

Now the functions of the above-described exemplary embodiment will be described.

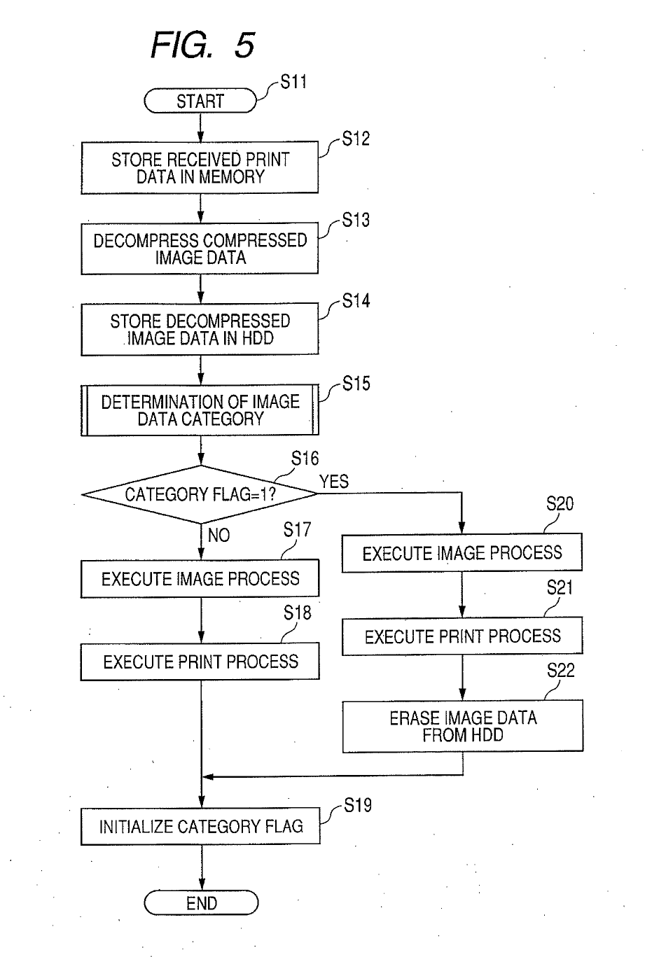

FIG. 5 is a flow chart illustrating basic operations, in the exemplary embodiment 1, that a host computer transmits a print job and executes a printing process.

More specifically, the unit for classifying the image data into plural categories by referring to the print mode setting, and the unit of executing, on the image data, the process set by the user for each category, will be described in succession from a stage of receiving the image data to a stage of printing.

At first the flow chart illustrating the basic operations of transmitting a print job from the host computer and executing a printing process will be described.

At first a printing process is initiated by the host computer (S11), and, when the main body of the printer receives the print data, the received print data is once stored in the memory (S12). The print data includes a compressed image data and information such as a print mode setting.

Subsequently, within the print data stored in the memory, the compressed image data portion is decompressed (or expanded) (S13). The image data after decompression is stored in the HDD 16 (S14). Then the image data is subjected, in a state stored in the HDD 16, to a category determination (S15). The “category” means a category of erasing the image data from the HDD 16 and a category of not erasing the image data from the HDD 16.

According to the result of category determination, a category flag is set at “0” or “1”. The subsequent data processing becomes different according to the value of the category flag (S16).

In the case that the category flag is “1”, the image data has to be erased from the HDD 16. However, after an image processing (S20) and a printing process (S21), the image data (image data after being printed) is erased (S22). During the execution of image processing and printing process, the HDD 16 stores the data in order to promptly execute the printing job. After the image data is erased from the HDD 16, the category flag is initialized (S19), whereupon the operations of the print job are terminated.

On the other hand, in the case that the category flag is “0”, the image data is not erased from the HDD 16. Therefore, after the image processing (S17) and the printing process (S18), the operations of the print job are terminated by merely initializing the category flag (S19). Thus, the image data after being printed is stored in the HDD 16.

FIG. 4 is a flow chart illustrating detailed operations in the image data category determination (S15) in the exemplary embodiment 1.

The image data category determination is initiated (S1) after the expanded image data is stored in the HDD 16. Then the image category determination unit 17 refers to the “print mode setting information” contained in the print job data (S2).

The “print data setting information” may be set by the user from the operation panel of the host computer or of the main body of the printer. Specific examples of the information include “CAD printing” and “poster printing”. The information referred to from the print job data is temporarily stored in an internal memory of the image category determination unit, and is used for a category determination (S3) to be executed for each print job. In addition, the image category determination unit memorizes “image category setting information”, set by the user.

Therefore, the image category determination unit can immediately determine whether the image data is to be erased from the HDD 16 (S4) by merely comparing “the print mode set information” referred from the print job data and the “image category set information” (FIG. 3). When the image data is determined as to be erased from the HDD 16, the category flag is set at “1” (S5). On the other hand, when the image data is determined as not to be erased from the HDD 16, the category flag is set at “0” (S6).

The category flag is stored in the internal memory of the image category determination unit, and is used for giving an instruction for data storage or data erasure to the HDD 16. When the category flag setting is completed, the process in the image data category determination unit is terminated.

In the following, there will be described a printing operation by the image data stored within the image forming system 100.

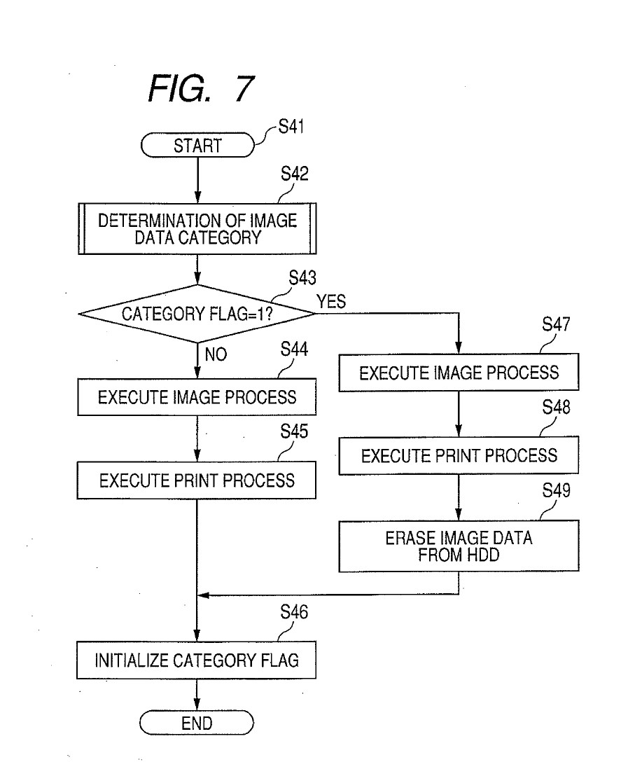

FIG. 7 is a flow chart illustrating the operation of printing process utilizing the image data stored in the image forming system 100.

The image data, to be designated as the print job, is limited to the data stored in the HDD 16 within the image forming system 100.

At first, a print job is initiated through the operation panel of the host computer or of the main body of the printer (S41). The user can start a print job by designating a thumbnail image display by a GUI on the host computer or on the operation panel, or by designating a file name display by a CUI.

When the user starts the print job, the image forming system 100 immediately executes a category determination process on said image data stored in the HDD 16 (S42). The category determination is same as that described in FIG. 4. The processing on the image data in the HDD 16 becomes different, depending on whether the category flag is set at “1” or “0” according to the result of such category determination (S43).

In the case that the category flag is “1”, after an image processing (S47) and a printing process (S48), the image data is erased from the HDD 16 (S49), and the category flag is finally initialized (S46), whereupon the print job is terminated.

Also in the case that the category flag is “0”, after the image processing (S44) and the printing process (S45), the category flag is initialized (S46) while the image data continues to be stored in the HDD 16, whereupon the print job is terminated.

In the following, there will be described an operation, in the exemplary embodiment 1, not utilizing the image category determination unit and the category setting unit.

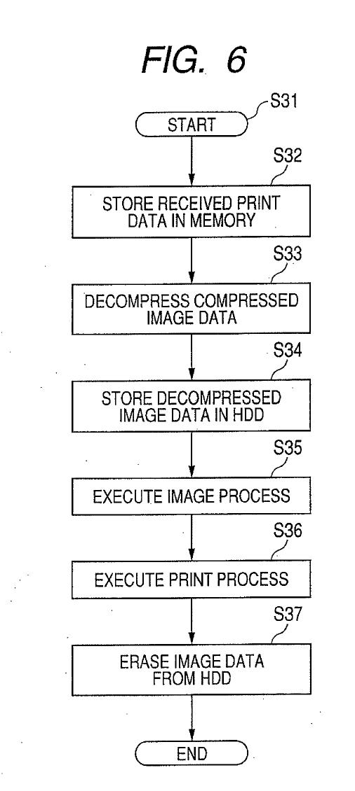

FIG. 6 is a flow chart illustrating operations in the exemplary embodiment 1, not utilizing the image category determination unit and the category setting unit.

At first a printing process is initiated by the host computer (S31). When the main body of the printer receives the print data, the received print data is once stored in the memory (S32). The print data includes a compressed image data and information such as a print mode setting.

Subsequently, within the print data stored in the memory, the compressed image data portion is decompressed (or expanded) (S33). The image data after decompression is stored in the HDD 16 (S34). Then the image data stored in the HDD 16 is subjected to an image processing (S35) and a printing process (S36).

Thereafter, the image data is erased from the HDD 16 (S37), whereby the operations of the print job are terminated. In case of operation without utilizing the image category determination unit and the category setting unit, the image data is not stored in the HDD 16, but, during the image processing and the printing process, the data is stored in the HDD 16 in order to execute the print job promptly.

### Exemplary Embodiment 2

The exemplary embodiment 1 described above executes classification of the image data into categories, by referring to the print mode setting information attached to the image data. The exemplary embodiment 2 of the present invention executes classification of the image data into categories, by referring to the image characteristics of the image data.

An image forming system 100 of the exemplary embodiment 2 has a construction similar to that illustrated in FIG. 1. Also basic operations in the exemplary embodiment 2 are same as those illustrated in the flow chart in FIG. 5.

Furthermore, the flow chart of the operations of the exemplary embodiment 2 in executing a printing process while the image data is stored within the image forming system is similar to the flow chart of the exemplary embodiment 1 illustrated in FIG. 7.

Further, the flow chart of the entire operations of the image forming system, in the case of not utilizing the image category determination unit and the category setting unit, is similar to the flow chart of the exemplary embodiment 1 illustrated in FIG. 6.

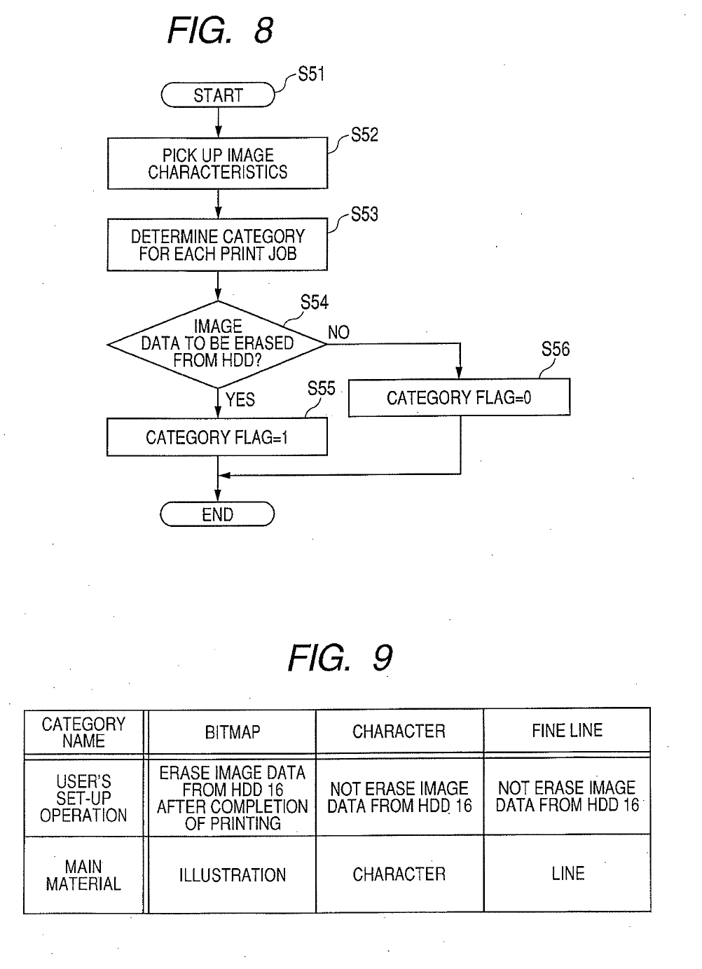

FIG. 8 is a flow chart illustrating operations of the exemplary embodiment 2 of the present invention.

The exemplary embodiment 2 is different, in the method of category determination, from the exemplary embodiment 1. After the image data, subjected to the decompression process in S13 in FIG. 5, is stored in S14 in the HDD 16, the image data category determination is initiated (S51). The image data category determination of S51 is also initiated when a start of a print job is instructed in S41 illustrated in FIG. 7. Then “image characteristic information” contained in the print job data is picked up and is referred to by the image category determination unit 17 (S52). The image characteristic information is a file format (filename expansion) of image data, color components constituting the image and a proportion of object attribute data. The referred information is temporarily stored in the internal memory of the image category determination unit, and is used for the category determination executed for each print job (S53).

In addition, the image category determination unit stores “image category setting information” set by the user. Therefore, the image category determination unit can immediately determine whether the image data is to be erased from the HDD 16 (S54) by merely comparing the “image characteristic information” referred from the print job data and the “image category set information” as illustrated in FIG. 3.

When the image data is determined as to be erased from the HDD 16, the category flag is set at “1” (S55). On the other hand, when the image data is determined as not to be erased from the HDD 16, the category flag is set at “0” (S56).

FIG. 9 is a chart illustrating a relationship, in the exemplary embodiment 2, among the category, CAD, poster and photograph.

For example, as illustrated in FIG. 9, when the image data is determined to have a large proportion of bit map data by referring to the object attribute data, such image is classified in a bit map category, and it is contemplated that for example, the category flag is set at “1”. The category flag is stored in the internal memory of the image category determination unit, and is used for giving an instruction for storing the data in the HDD 16 or an instruction for erasing the data from the HDD 16. When the category flag is set, the process in the image data category determination (S15) is terminated.

### Exemplary Embodiment 3

The exemplary embodiment 3 of the present invention is to determine, in the image forming system, whether or not the image data is to be stored in the HDD 16 over a long time period, at a stage of reception of the image data.

In the foregoing exemplary embodiments 1 and 2, the prolonged storage in the HDD 16 is determined after the image data is temporarily stored in the HDD 16.

However, in the printing operation, the temporary storage of the image data in the HDD 16 is not essential, so that the exemplary embodiment 3 determines whether or not to store the image data over a long time period in the HDD 16, at the stage when the image data is received by the image forming system. In this case, when the image data need not be stored over a long time period, the printing process may be executed in S44 without storing the decompressed image data in the HDD 16 in S11 illustrated in FIG. 4.

As described above, the foregoing exemplary embodiments are applicable to an image forming system, that prints an image based on image data. The foregoing exemplary embodiments enables to effectively utilize the limited memory area, by classifying the image data into plural categories and by setting the process conditions at the printing operation by the user for each category.

As described by exemplary embodiments, the present invention provides an effect, in an image forming system capable of printing an image based on image data, of deleting data unnecessary for the user, thereby achieving an effective utilization of the limited memory area.

The foregoing exemplary embodiments relate to a printer, but these are also applicable to image data entered from a scanner, in a copying machine equipped with an image scanner. Also the determination of the categories for the image data and the determination whether or not to store the image data in the HDD 16 may be executed in the main body of the printer or by the printer driver of the host computer.

Furthermore, the above-described image forming system may be applied to a laser beam printer or other printing systems such as of an electrophotographic system.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-190544, filed Jul. 11, 2006, which is hereby incorporated by reference herein in its entirety.

What is claimed is:

1. An image forming apparatus for printing an image based on image data, comprising:
a memory unit for memorizing the image data;
a determination unit for determining a category of the image data; and
a selection unit for selecting whether to erase or to store the image data after being printed, according to a result of determination by the determination unit.

2. The image forming apparatus according to claim 1, wherein the determination unit determines the category of the image data, according a set mode of a printer in printing the image data.

3. The image forming apparatus according to claim 1, wherein the category of the image data is determined according to image characteristics of the image data.

4. The image forming apparatus according to claim 2 or 3, further comprising a setting unit for setting, by a user for each category, whether to erase or to store the image data.

5. The image forming apparatus according to claim 4, wherein the setting unit sets whether to erase or to store the image data, by an operation from at least either of a host computer and an operation panel of the image forming apparatus.

6. A control method for an image forming apparatus for printing an image based on image data, the method comprising:
memorizing the image data in a memory unit;
determining a category of the image data; and
selecting whether to erase or to store the image data after being printed, according to a result of said determination.

7. A computer readable memory medium storing a program for causing an image forming apparatus to execute:
a procedure of memorizing the image data in a memory unit;
a procedure of determining a category of the image data; and
a procedure of selecting whether to erase or to store the image data after being printed, according to a result of said determination.
